(19) United States
(12) Patent Application Publication
(10) Pub. No.: US 2017/0371048 A1
(43) Pub. Date: Dec. 28, 2017

(54) BURIED SEISMIC SENSOR AND METHOD

(71) Applicant: CGG SERVICES SAS, Massy Cedex (FR)

(72) Inventor: John James SALLAS, Plano, TX (US)

(21) Appl. No.: 15/543,593

(22) PCT Filed: Nov. 24, 2015
(86) PCT No.: PCT/IB2015/002446

§ 371 Date: Jul. 14, 2017

Related U.S. Application Data
(60) Provisional application No. 62/117,467, filed on Feb. 18, 2015.

(51) Int. Cl. G01V 1/16

(52) U.S. Cl. CPC G01V 1/166

(57) ABSTRACT

A seismic device for recording seismic waves includes a housing to be located in a fill-in material and/or a formation, a first assembly located inside the housing, and a first anchor attached to the first assembly and exiting through the housing to contact the fill-in material and/or the formation. The first assembly is configured to measure a quantity indicative of a strain experienced by the formation due to the seismic waves.

### PRIORITY INFORMATION

The present application claims priority under 35 U.S.C. §119(e) to U.S. Provisional Patent Application Ser. No. 62/117,467, filed Feb. 18, 2015, the entire contents of which are expressly incorporated herein by reference.

### TECHNICAL FIELD

The present embodiments relate generally to land seismic exploration systems and methods, and more specifically to systems and methods for receivers used in land seismic exploration systems.

### BACKGROUND

Seismic waves generated artificially have been used for more than 50 years to perform imaging of geological layers. During seismic exploration operations, vibrator equipment or dynamite (also known as a “source”) generates a seismic signal that propagates in the form of a wave that is reflected at interfaces of geological layers. For land seismic surveying, these reflected waves are typically received by geophones, or more generally “receivers,” which convert the displacement of the ground resulting from the propagation of the waves into an electrical signal which is recorded. Analysis of the arrival times and amplitudes of these waves make it possible to construct a representation of the geological layers on which the waves are reflected.

FIG. 1 depicts schematically a system 100 for transmitting and receiving seismic waves intended for seismic exploration in a land environment. System 100 includes a source 102 consisting of a vibrator operable to generate a seismic signal, a set of receivers 104 for receiving a seismic signal and converting it into an electrical signal and a recorder 106 (or central station) for storing the electrical signals generated by the receivers. Source 102, receivers 104 and recorder 106 are positioned on the surface of the ground 108. FIG. 1 depicts source 102 as a single vibrator, but it should be understood that the source may be composed of several vibrators, as is well known to persons skilled in the art.

In operation, source 102 is operated to generate a seismic signal. This signal propagates firstly on the surface of the ground (known as ground roll or Rayleigh waves), in the form of surface waves 110, and secondly in the subsoil, in the form of transmitted waves 112 that generate reflected waves 114 when they reach an interface 115 between two geological layers 116 and 118. In a solid medium, the waves radiated by a source (transmitted waves 112) are a combination of P-waves (pressure waves) and S-waves (shear waves). P-waves produce, as they pass through the media, localized volumetric changes in the media while S-waves produce a localized distortion in the media with corresponding particle motion.

The surface wave 110 produces a retrograde particle motion in the soil, but there is no local volumetric change associated with it as it propagates. The propagation velocity for surface waves and S-waves is much less than for P-waves. Typically, the fraction of P-wave radiated energy from a surface source is about 8%, with surface waves and S-waves comprising the remaining 92% of the total radiated wave energy. Surface waves 110, decay with depth, but they decay more slowly at low frequencies, so they can still have significant amplitude even at 100 m depth for example.

Each receiver 104 receives both a surface wave 110 and a reflected wave 114 and converts them into an electrical signal, which signal thus includes a component associated with the reflected wave 114 and another component associated with the surface wave 110. Since system 100 intends to image the subsurface layers 116 and 118, including a hydrocarbon deposit 120, the component in the electrical signal associated with the surface wave 110 is undesirable and should be filtered out. In general, most reflection seismology today use the reflection data associated with P-wave emissions and their reflections. In many cases, S-waves are not used and oftentimes treated as another undesired source of coherent noise. For the case of reservoir monitoring, where a high degree of repeatability may be required, it should be noted that source 102 may be a buried source rather than a surface source. One such reservoir monitoring system that employs buried sources is described in U.S. Pat. No. 6,714,867. Buried receivers can also be useful for monitoring/imaging other oil-field processes like fracture monitoring, where the receiver is located closer where a microseismic event might be created by fluid injection; or for passive seismic monitoring in which case the seismic source may be drills, natural phenomena like earthquakes or ocean tides.

Historically, land seismic systems 100 have typically employed geophones as receivers 104. A geophone is a device that converts ground movement into voltage. Geophones use either a spring mounted magnetic mass or a spring mounted coil. More recently an analogous MEMS device has been introduced. The deviation of this measured voltage from a base line is the seismic response which can be analyzed to image the subsurface regions 116, 118 and 120. By way of contrast, hydrophones have typically been employed for marine seismic systems. A hydrophone is essentially a microphone designed to be used underwater for recording or listening to underwater sound. Most hydrophones are based on a piezoelectric transducer that generates electricity when subjected to a pressure change. Such piezoelectric materials or transducers can convert a sound signal into an electrical signal since sound is a pressure wave. Although geophones have typically been used as receivers 104 in land seismic operations, and hydrophones have typically been used as receivers in marine seismic operations, in certain cases these roles have been reversed and indeed today some seismic systems are being designed to use both types of sensors as receivers.

Reservoir monitoring systems are becoming more common. 4-D survey techniques are used to detect subtle changes in seismic images over time. Changes in the reservoir image are useful for detecting changes in reservoir fluid volumes and their locations. This information is useful for enhanced recovery of hydrocarbons, for example, by providing information to operators that pumping schedules need to be adjusted either for fluid extraction or injection or to help decide if other processes to improve fluid communication need to be applied.

Because the data in these instances is for 4-D studies, with the fourth dimension being time, subtle changes in seismic images over time are monitored. This monitoring requires that factors like soil temperature or soil moisture content not affect the image. By cementing the receivers in place at depth, changes in acoustic properties in the media and changes in coupling to the formation, due to rain and other factors is mitigated. In some places, sources are buried at depth and cemented into the formation. In other cases, surface sources like seismic vibrators are used. In many cases, the vibrators operate on pads that may be poured concrete or other surface preparation to improve repeatability, by fixing the surface source position and coupling with the medium.

Because of cost constraints, the number of cemented/buried receivers is limited. Consequently, processing methods typically used in conventional reflection seismology for removal of unwanted coherent noise, like Rayleigh waves, cannot be used in many cases. Buried receivers in the past have been primarily geophones, which detect particle velocity and are sensitive to both body waves and Rayleigh waves/ground roll. So receivers that are relatively insensitive to Rayleigh waves but still can detect body waves like P-waves and/or S-waves would be helpful. Recently, buried hydrophones have been introduced as a means for detecting body waves in solids. Hydrophones are high output impedance devices and typically require either a charge amplifier or transformer to provide a signal compatible with standard seismic acquisition systems. Hydrophones also tend to be omnidirectional devices, so they are just as sensitive to P-waves traveling horizontally as to reflected waves coming from interfaces at depth that are of greatest interest.

Therefore, there is a need for a new seismic sensor that is less sensitive to coherent noise like Rayleigh waves, has low intrinsic output impedance and is directional.

### SUMMARY

An aspect of the embodiments is to substantially solve at least one or more of the problems and/or disadvantages discussed above, and to provide at least one or more of the advantages described below.

It is therefore a general aspect of the embodiments to provide a seismic device for recording seismic waves. The device includes a housing to be located in a fill-in material and/or a formation; a first assembly located inside the housing; and a first anchor attached to the first assembly and exiting through the housing to contact the fill-in material and/or the formation. The first assembly is configured to measure a quantity indicative of a strain experienced by the formation due to the seismic waves.

In one aspect, there is a seismic device for recording seismic waves. The device includes a housing to be embedded in a fill-in material and/or a formation; a first magnetic assembly located inside the housing; a second magnetic assembly located inside the housing; and a rigid member located inside the housing and separating the first magnetic assembly from the second magnetic assembly. The first and second magnetic assemblies generate corresponding first and second voltages, a difference of which is indicative of a strain experienced by the formation due to the seismic waves.

According to another aspect, there is a method for determining a time derivative of a strain in a fill-in material and/or formation. The method includes placing a seismic device in a well; filling the well with the fill-in material so that the seismic device is surrounded by the fill-in material; generating a seismic wave with a seismic source; and measuring a quantity indicative of a strain in the fill-in material and/or the formation with the seismic device, wherein the strain in the fill-in material and/or the formation is a result of the seismic wave passing through the fill-in material and/or the formation.

### BRIEF DESCRIPTION OF THE DRAWINGS

The above and other aspects and features of the embodiments will become apparent and more readily appreciated from the following description of the embodiments with reference to the following figures, wherein like reference numerals refer to like parts throughout the various figures unless otherwise specified, and wherein:

FIG. 1 depicts schematically a device for transmitting and receiving seismic waves intended for seismic exploration in a land environment;

FIG. 2 is a flowchart of a method for acquiring and processing seismic data;

FIG. 3 illustrates a seismic sensor that determines a time derivative of a strain in a formation;

FIG. 4 illustrates a coil of the seismic sensor of FIG. 3;

FIG. 5 illustrates another seismic sensor that determines a time derivative of a strain in a formation;

FIG. 6 illustrates yet another seismic sensor;

FIG. 7 illustrates still another seismic sensor that determines a time derivative of a strain in a formation;

FIG. 8 illustrates a seismic sensor that uses a piezoelectric assembly for determining a time derivative of a strain in a formation;

FIG. 9 illustrates the piezoelectric assembly;

FIG. 10 illustrates a seismic sensor that uses a transducer assembly for determining a strain in a formation;

FIGS. 11A-B illustrate the transducer assembly;

FIG. 12 illustrates a multi-component seismic sensor; and

FIG. 13 is a flowchart of a method for measuring the time derivate of a strain in a formation.

### DETAILED DESCRIPTION

The embodiments are described more fully hereinafter with reference to the accompanying drawings, in which embodiments of the novel concept are shown. In the drawings, the size and relative sizes of layers and regions may be exaggerated for clarity. Like numbers refer to like elements throughout. The embodiments may, however, be embodied in many different forms and should not be construed as limited to the embodiments set forth herein. Rather, these embodiments are provided so that this disclosure will be complete, and will convey the scope of the associated concepts to those skilled in the art. It will be apparent to one skilled in the art, however, that at least some embodiments may be practiced without one or more of the specific details described herein. In other instances, well-known components or methods are not described in detail or are presented in simple block diagram format in order to avoid unnecessarily obscuring the embodiments. The scope of the embodiments is therefore defined by the appended claims. The following embodiments are discussed, for simplicity, with regard to the terminology and structure of a land seismic exploration system, but are not necessarily limited thereto.

Reference throughout the specification to “one embodiment” or “an embodiment” means that a particular feature, structure, or characteristic described in connection with an embodiment is included in at least one embodiment of the present embodiments. Thus, the appearance of the phrases “in one embodiment” on “in an embodiment” in various places throughout the specification is not necessarily referring to the same embodiment. Further, the particular feature, structures, or characteristics may be combined in any suitable manner in one or more embodiments.

As mentioned above in the Background section, it would be desirable to overcome some of the various problems and difficulties associated with seismic sensors used in seismic acquisition, and in particular, where such seismic sensors are used, for example, in 4D land seismic acquisition. The following embodiments address this challenge by, among other things, providing a new seismic device that has a coil-magnet system that is capable of measuring a time derivative of a strain in a subsurface formation. Other embodiments, described below, address the same or similar challenges using different configurations. Some of the embodiments discussed herein measure directly the strain and not its derivative. In one application, it is possible to measure the second derivative of the strain and then estimate the strain. In other words, the embodiments discussed herein measure a quantity indicative of the strain and this quantity can be the strain itself, the first derivative of the strain, the second derivative of the strain or any other parameter from which the strain may be estimated.

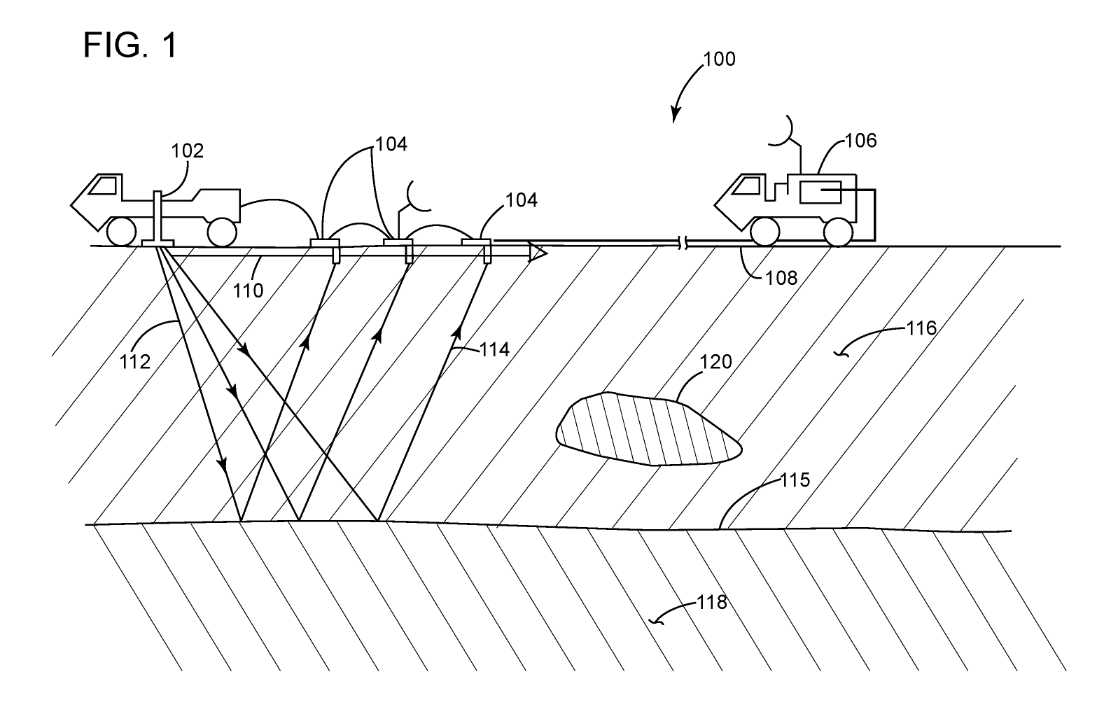

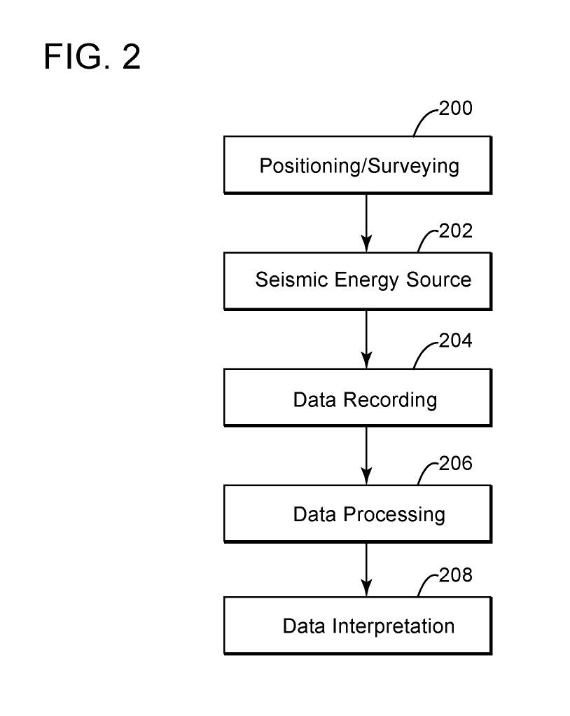

Prior to describing such seismic sensor according to embodiments in more detail, an additional brief discussion of the overall seismic exploration or acquisition process will first be provided for context. As generally discussed above, one purpose of seismic exploration is to render the most accurate graphical representation (e.g., image) possible of specific portions of the Earth's subsurface geologic structure, e.g., using the data which is collected as described above with respect to FIG. 1. The images produced allow exploration companies to accurately and cost-effectively evaluate a promising target (prospect) for its oil and gas yielding potential (e.g., hydrocarbon deposit 120). FIG. 2 illustrates a generalized method for seismic exploration which includes both the acquisition of the seismic data described above, and the subsequent processing of that seismic data to form such images. In FIG. 2, the overall process is broken down into five steps, although one could of course characterize seismic exploration in a number of different ways. Step 200 references the initial positioning of the survey equipment in the geographic area of interest (GAI) and the preparation to begin surveying the GAI in a manner which is precise and repeatable. Seismic waves are generated in step 202 by the afore-described sources or vibrators, and data recording is performed in step 204 on the direct, refracted, reflected, scattered and surface waves (note that surface waves may propagate not only at the surface as direct waves, but also at layer interfaces if there is a change in the acoustic impedance) by the seismic sensors. As will be appreciated, the seismic sensors according to the embodiments described below, can be envisioned as impacting both steps 200 and 204, since they will, for example, be positioned in respective boreholes and also perform part of the step of recording the data in their roles as receiver/transducer.

In step 206, processing of the raw, recorded seismic data occurs. Data processing generally involves numerous processes intended to, for example, remove noise and unwanted arrivals/reflections from the recorded data and involves a significant amount of computer processing resources, including the storage of vast amounts of data, and multiple processors or computers running in parallel. Such data processing can be performed on site, back at a data processing center, or some combination thereof. Finally, in step 208, data interpretation occurs and the results can be displayed or generated as printed images, sometimes in two-dimensional form, more often now in three dimensional form. Four dimensional data presentations (i.e., a sequence of 3D plots or graphs over time) are also possible outputs, when needed to track the effects of, for example, extraction of hydrocarbons from a previously surveyed deposit

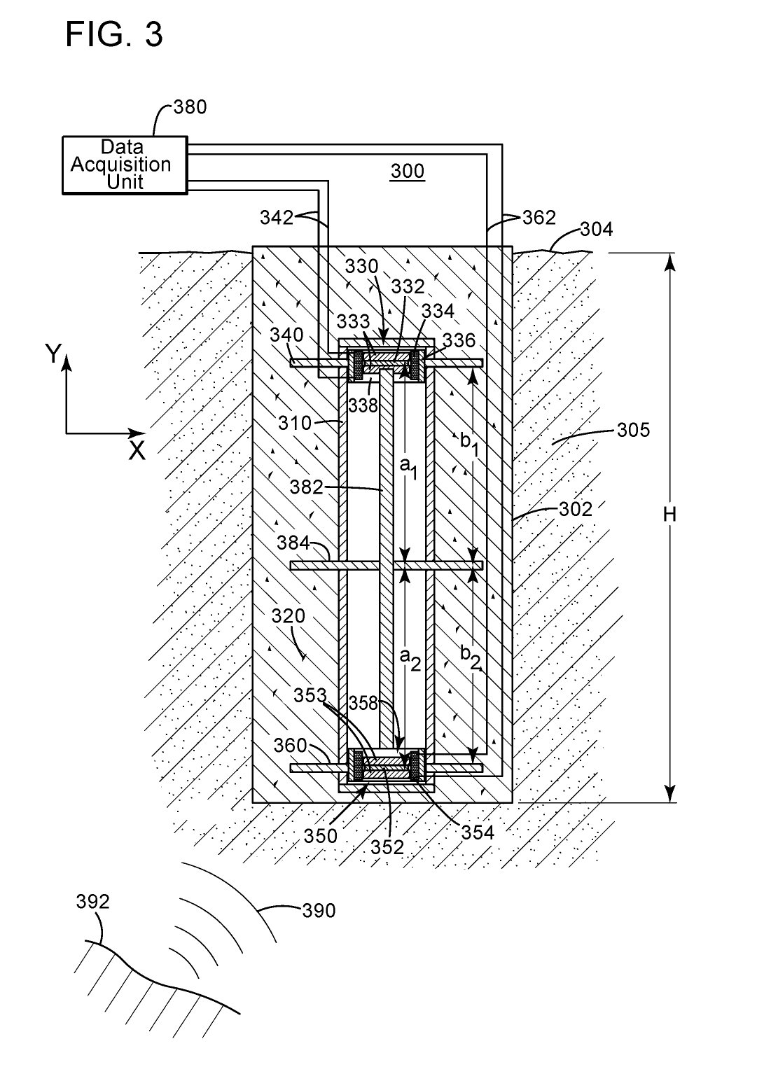

With this context in mind, an embodiment of a buried seismic sensor is now discussed with respect to FIG. 3. A land seismic system such as that illustrated and described above with respect to FIG. 1 can be used in conjunction with seismic sensor embodiments described herein, with the exception that boreholes 302, each of which contain a separate buried seismic sensor 300, provide seismic wave reception capability as opposed to receivers 104 being disposed on the surface of the area to be surveyed. As those of skill in the art can appreciate, additional boreholes 302 can be included in a given implementation with respective seismic sensors 300 to cover a desired GAI. In one embodiment, sensor(s) 300 can be used with hydrophones, geophones and/or accelerometers for collecting seismic data.

In this embodiment, the buried seismic sensor 300, as shown in FIG. 3, includes a housing 310 that is placed in borehole 302. Those skilled in the art would understand that borehole 302 may simply be a hole, a ditch, a well or any depression in the ground. The borehole may be vertical, horizontal or slanted. In one application, a depth H of a bottom of hole 302 from the surface 304 is between 3 and 50 m. In one embodiment, borehole 302 includes a single seismic sensor 300. In another embodiment, borehole 302 includes plural seismic sensors 300. In another embodiment, the seismic sensor 300 is buried vertically in borehole 302 and the borehole is backfilled with a given material 320, e.g., cement, concrete, sand, clay, etc. In another embodiment, the seismic sensor is tilted inside the borehole or the borehole itself is tilted.

Housing 310 may be made of a material, e.g., plastic, that prevents humidity and/or impurities from the well entering the seismic sensor, and also has a rigid structure. Other materials than plastic may be used. The housing also needs to be stiff enough not to collapse under the pressure of the fill-in material, but have an elastic modulus much less than the fill-in material so that anchors 340 and 360, to be discussed later, move with the formation 305 and/or the fill-in material and are not constrained by the housing. Housing 310 hosts an upper magnet assembly 330 and a lower magnet assembly 350, each capable of measuring an electromagnetic force (EMF) induced by the relative movement of a magnet relative to a coil. This movement originates from a seismic wave interacting with the housing 310. The two magnet assemblies 330 and 350 are configured to measure a time derivative of the strain generated by the seismic wave in borehole 302. The magnet assemblies measure the time derivative of the strain (i.e., strain rate) of the fill-in material and/or the formation 305. In one embodiment, this is achieved without fill-in material 320, by cementing anchors (to be discussed later directly to the formation).

The upper magnet assembly 330 may be equipped with a magnet 332 sandwiched between ferromagnetic pole piece 333. Magnet 332 is surrounded by upper coil 334. Magnet 332 may include one or more magnets. Upper coil 334 has its bobbin encapsulated within coil holder 336, which is ferromagnetic. As the coil bobbin is non-ferromagnetic, the coil holder completes the magnetic circuit. Note that there is a small circumferential air gap 338 between magnet 332 and coil 334 to permit the free motion of the magnet relative to the upper coil. In the embodiment discussed herein, the coil is fixed relative to the housing while the magnet moves relative to the upper coil. In another embodiment, it is possible to have the magnet fixed to the housing and the upper coil free to move. In still another embodiment, the gap 338 could be filled with grease or compliant elastomer or a slick bushing, for example, made from Teflon material.

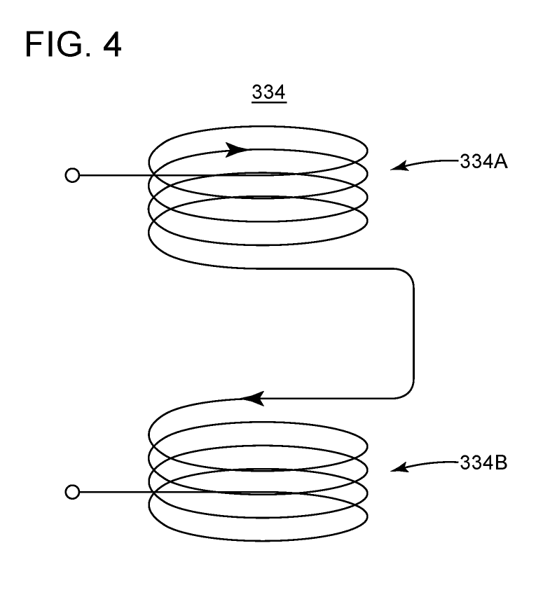

In this embodiment, upper coil 334 is illustrated as a single device having a number of turns N. However, in one application, upper coil 334 is made of two coils 334A and 334B, which are turning in opposite directions as illustrated in FIG. 4. This arrangement is called a hum bucking coil and can be used for rejecting certain frequencies (e.g., 50 or 60 Hz) that are associated with the power grid.

In this embodiment, coil holder 336 is rigidly attached to upper anchor 340, which is encased in fill-in material 320. Upper anchor 340 is shown in FIG. 3 as a rigid plate. However, it can be a flange, or a metal pipe or some other rigid material for attaching coil holder 336 to fill-in material 320. Upper anchor 340 is shown penetrating housing 310 and extending into fill-in material 320. In one embodiment, it is possible that upper anchor 340 is fixedly attached to housing 310, without existing the housing. A pair of wires 342 is attached to upper coil 334 and the wires are exiting the borehole for communicating the induced voltage to a data acquisition unit 380. Data acquisition unit 380 may be located at the surface, as shown in FIG. 3, or somewhere on housing 310.

At the bottom of the housing 310, there is located the second magnet assembly 350, that has a similar structure as the first magnet assembly 330. Magnet 352 may be sandwiched between pole pieces 353 and lower coil 354 encircles magnet 352. A coil holder 356 supports lower coil 354 and a pair of wires 362 connects the lower coil to data acquisition unit 380. Lower coil 354 is fixed relative to fill-in material 320 due to anchor 360, which extends into the fill-in material.

First and second magnet assemblies 330 and 350 are connected to one another via rigid member 382, which in one embodiment is a metal pipe. Rigid member 382 may be attached at its midpoint to anchor 384, which can be a plate, flange or other structure for attaching rigid member to fill-in material 320. In this way, the distance between the magnets of the two magnet assemblies is constant and does not change in time. Further, by fixing the rigid member 382 to the fill-in material, it is expected that the two magnets 332 and 352 would not move relative to each other. However, the two coils 334 and 354 are expected to move relative to each other as the seismic waves strain the fill-in material.

When in operation, seismic sensor 300 experiences the following actions. A pressure wave 390, for example, from a rock interface 392 at a certain depth below the surface, is propagating upwards (along Y direction, which coincides with gravity) toward the surface 304. As the wave 390 passes through seismic sensor 300, there will be a change in the distance separating lower anchor 360 and upper anchor 340. During the compression portion of the pressure wave 392's arrival, a separation distance b1+b2 between the two anchors will decrease, and during the rarefaction portion of the pressure wave 392, this axial dimension will increase. Because upper and lower coils 334 and 354 are tied into the fill-in material 320, their separation distance will change as the pressure wave passes. However, a distance a1+a2 between magnets 332 and 352 will not change. This is so because bar 382 is rigid and has its endpoints isolated from the fill-in material. Only the midpoint of bar 382 is tied to the formation through anchor 384. Thus, even if the bar moves up and down, the separation distance a1+a2 will remain fixed (it is assumed that the bar and plate are stiff at the frequencies of interest, i.e., below 200 Hz).

When these movements take place, the magnets slightly move relative to the upper and lower coil, thus, inducing an EMF voltage in each coil. These voltages are transmitted by pairs of coils 342 and 362 to data acquisition unit 380. Thus, data acquisition unit 380 receives a first voltage e1, measured across pair 362, and this voltage is proportional to the relative velocity of coil 354 with respect to magnet 352. This means that the output voltage e1 is proportional to the velocity of anchor 360 relative to anchor 384. Likewise, voltage e2 is measured across pair 342, which is connected to coil 334, and this voltage is proportional to the relative velocity of coil 334 relative to magnet 332. Alternatively, pairs 343 and 362 are interconnected in such a way to directly record voltage e3. This approach allows a higher sensitivity setting on the recorder to recover lower energy signals from greater depth.

If the magnets and coils are polarized at both ends of the seismic sensor, so that a downward motion of the coil relative to the magnet creates a positive voltage, that means that e1>0 and e2>0. By forming the difference voltage e3=e1−e2 by interconnecting the pair of wires or in data acquisition unit 380, it is possible to obtain a voltage that is proportional to the differential velocity between anchors 360 and 340. In other words, with the configuration shown in FIG. 3, it is possible to measure the rate of change (or the time derivative) of the strain, in the vertical axial dimension, of the fill-in material (one objective of the seismic sensor is to determine the strain or strain rate in the formation in which the fill-in material is provided; this objective may be achieved by measuring the strain or strain rate of the fill-in material; however, it is possible to also achieve this objective by having the anchors bonded to the formation), as the pressure wave passes through it. Note that although the embodiments are discussed as the magnets are moving and the coils are fixed, the inventive concepts equally apply to a system having the magnets fixed and the coils moving relative to the magnets. For this reason, the term “movement of the magnets relative to the coils” means either the coils are fixed and the magnets are moving or the coils are moving and the magnets are fixed.

Due to the location of the two magnet assemblies, i.e., along the vertical axis Y, the seismic sensor 300 will have a directional response in terms of P-waves response (P-waves behave like plane waves far away from their source and thus, they extend or contract the medium in the direction of their propagation). This means that the seismic sensor 300 will tend to have a cosine response to a pressure wave arriving at angles away from vertical. This means that for a pressure wave arrival at 30° degrees from the gravity axis, the sensitivity of the seismic sensor will decrease to about 86.6%, and for a pressure wave arrival that is in the horizontal direction X (like the ground roll waves), the sensitivity of the seismic sensor (if the coils are matched) will approach zero, as desired. In other words, the seismic sensor 300 illustrated in FIG. 3 would detect the strain changes in the fill-in material without recording the ground roll waves. While orienting the seismic sensor may be useful to boost sensitivity to P-waves in a preferred direction in one embodiment, it is also possible, in another embodiment, to orient the seismic sensor to reject S-waves that are arriving from the same direction as the P-waves. Thus, orienting the seismic sensor's central axis in line with the P-wave arrivals may also be helpful in rejecting S-waves coming from the same direction.

In another embodiment, at the time of manufacture, if it is found that coils 334 and 354 and magnets 332 and 352 are not well matched (e.g., they do not have the same velocity sensitivity), external components (for example, series and shunt resistors) can be used to improve the matching.

For a practical implementation of the seismic sensor 300, the distance b1+b2 might be about 1 m, but other dimensions are possible. In general, the greater the separation distance, the more sensitive the seismic sensor will become.

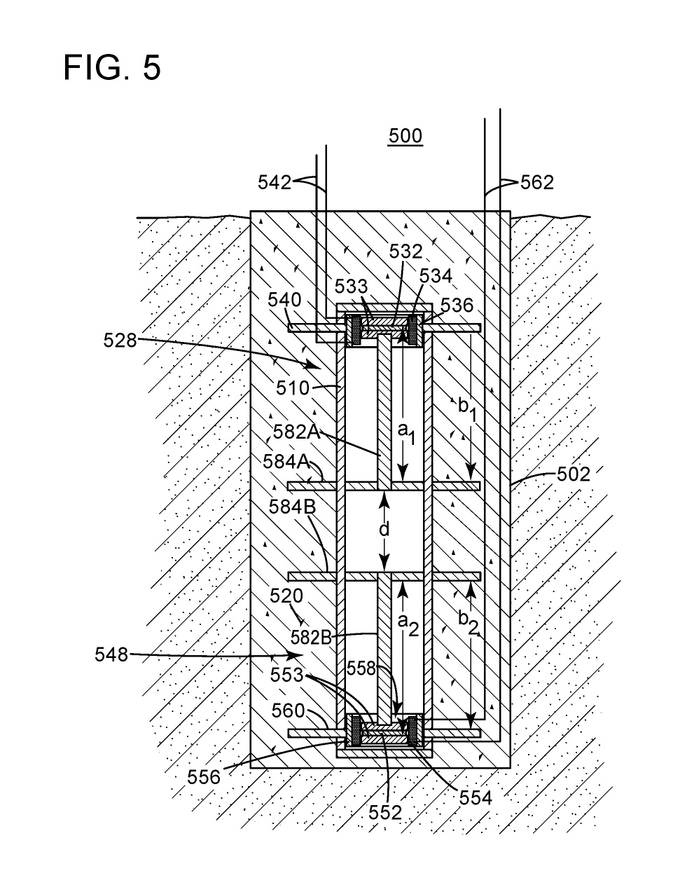

Seismic sensor 300 discussed above is one possible implementation of the inventive concept. FIG. 5 shows another possible implementation of a seismic sensor 500 capable of measuring seismic waves while reducing the impact of ground roll. Seismic sensor 500 includes two separate units, an upper unit 528 that measures the axial dilation b1 and a lower unit 548 that measures dilation b2. In this case, rigid member 382 in FIG. 3 is split into two parts, 582A and B, each one corresponding to one of the upper and lower units. Anchor 384 from FIG. 3 is also split into two anchors 584A and B. All other elements in the embodiment of FIG. 5 are similar to those of FIG. 3, and for this reason, similar parts are not discussed herein. By choosing the proper interconnection of the coils 534 and 554, it is possible to measure the overall dilation b1+b2. A distance d between anchors 584A and B is can be adjusted depending on the field conditions, and it may be added to the overall dilation if necessary.

In another embodiment, the distance d may be made zero, which means that anchors 584A and 584B are attached to each other by fasteners. Thus, devices 528 and 548 may be manufactured separately.

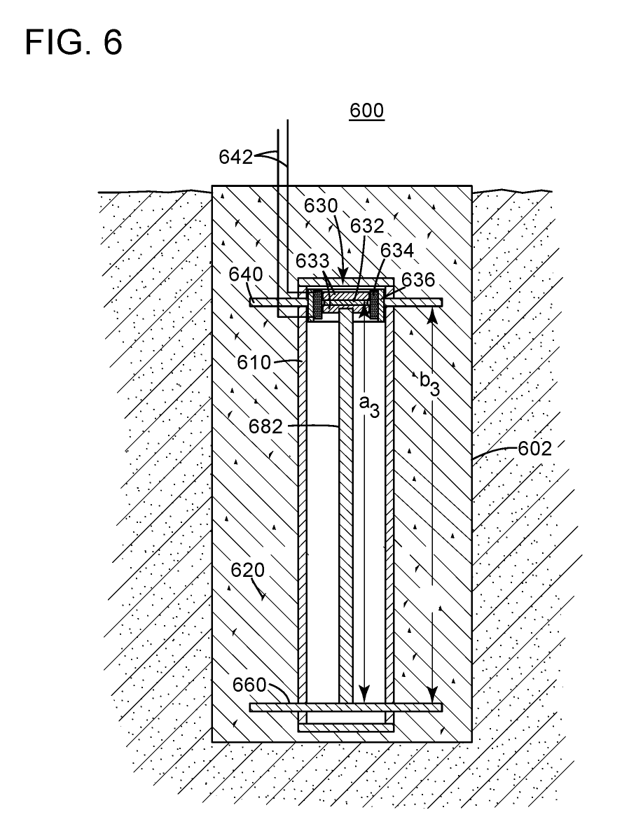

In still another embodiment, as illustrated in FIG. 6, seismic sensor 600 has a single magnet assembly 630, located at the upper or lower half of the sensor. FIG. 6 shows an embodiment in which single magnet assembly 630 is located at the upper half of housing 610. However, it is possible to have the single magnet assembly 630 located in the lower half of the housing. Bar 682 is directly connected with one end to anchor 660 while the other end is connected to magnet 632. In this embodiment, seismic sensor 600 measures the relative velocity of upper anchor 640 relative to lower anchor 660. Lower anchor 660 may be located anywhere inside housing 610. However, in one embodiment, the lower anchor is located at one end of the housing. The relative velocity is represented by a voltage output e3 that is present on wire pair 642, which is connected to coil 634.

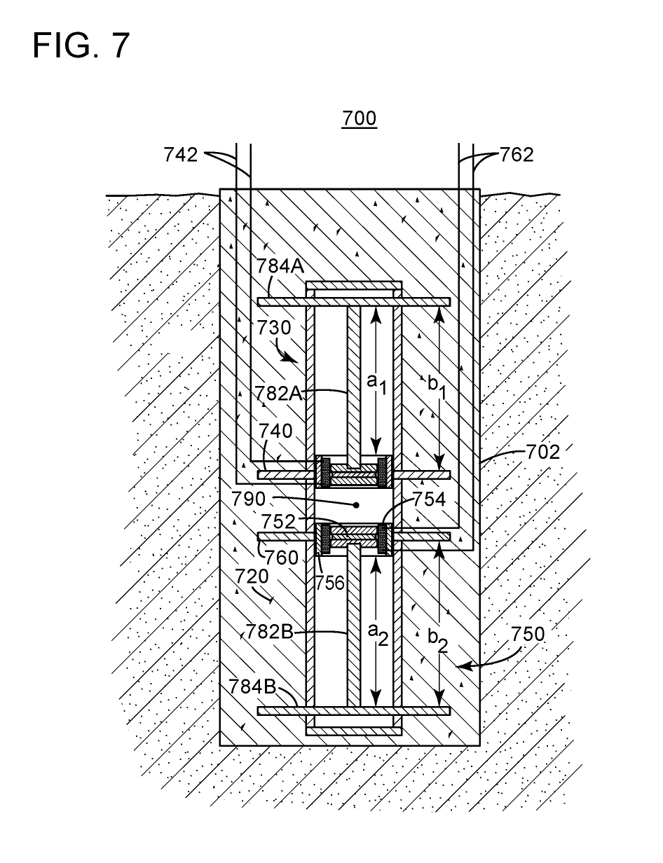

In still another embodiment, as illustrated in FIG. 7, a seismic sensor 700 may have two magnet assemblies 730 and 750, similar to the embodiment of FIG. 3, but the magnet assemblies are located near the center 790 of the axial length of the housing. Thus, anchor plates 740 and 760 may be joined to each other near the midpoint of the housing and anchor plate 384 is replaced by two plates 784A and B, which are now located at the top and bottom, respectively, of housing 710. Those skilled in the art would understand that these elements may be placed at other locations inside the housing.

Although the above embodiments discussed placing the seismic device in a vertical borehole, in an embodiment, the seismic device could be installed in a slanted borehole, to be more sensitive to body waves arriving from a direction other than vertical or to reject certain arrivals that are undesirable, e.g., S-waves.

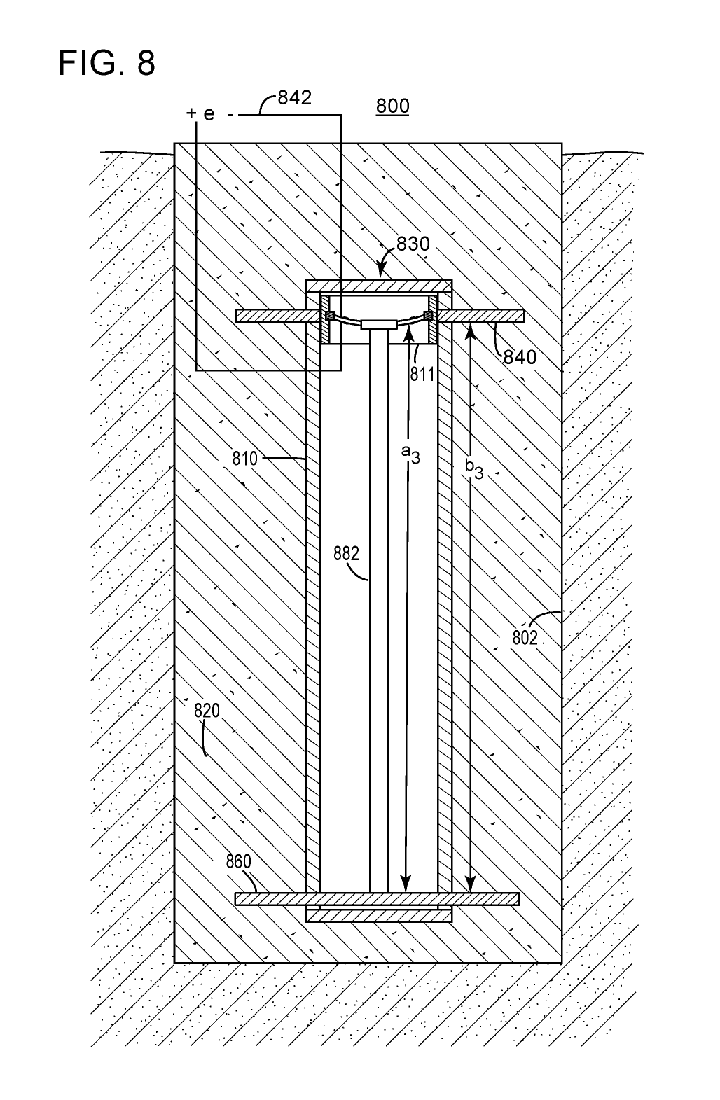

The above embodiments discussed a seismic device having one or more magnetic assemblies for measuring a voltage indicative of a time derivative of the medium's strain. However, as discussed now, it is possible to replace the magnetic assemblies with other type of sensors. In this respect, FIG. 8 shows a seismic sensor having at least one piezoelectric assembly 830 located at one end of housing 810. Note that most reference numbers shown in this figure point to similar components as the corresponding reference numbers in FIG. 3, except for piezoelectric assembly 830.

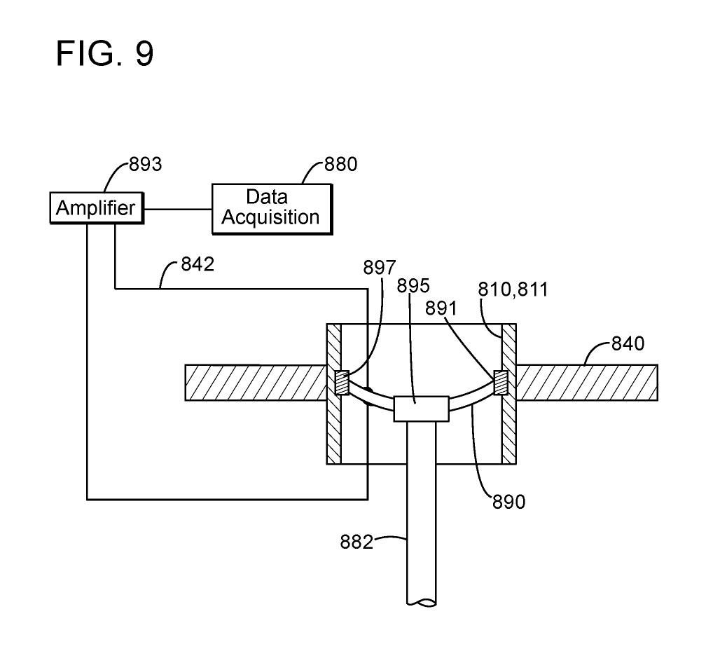

Piezoelectric assembly 830 is shown in more detail in FIG. 9, and it includes a piezoelectric element 890 having its ends 891 fixed to housing 810 or another local housing 811. If the ends 891 of the piezoelectric element 890 are attached to local housing 811, for example, with a bonding material 897, a central part of the material 890 is attached to rod 882 via connecting device 895, for example, a hub or a bonding material. Wires 842 are attached to the two opposite faces of piezoelectric element 890 for measuring the voltage induced by its deformation.

The piezoelectric element could be a PZT disc that has been polarized and has electrodes (for example silver or nickel deposition) on the upper and lower parts with wires attached, which are brought out to a charge amplifier 893, that can be located in close proximity at/or near the surface, and the data acquisition unit 880. If there is relative motion between the central bar 882 and the anchor 840 near where the piezoelectric element is positioned, then an electric charge will be generated. The rate of change in the charge should be proportional to the strain rate.

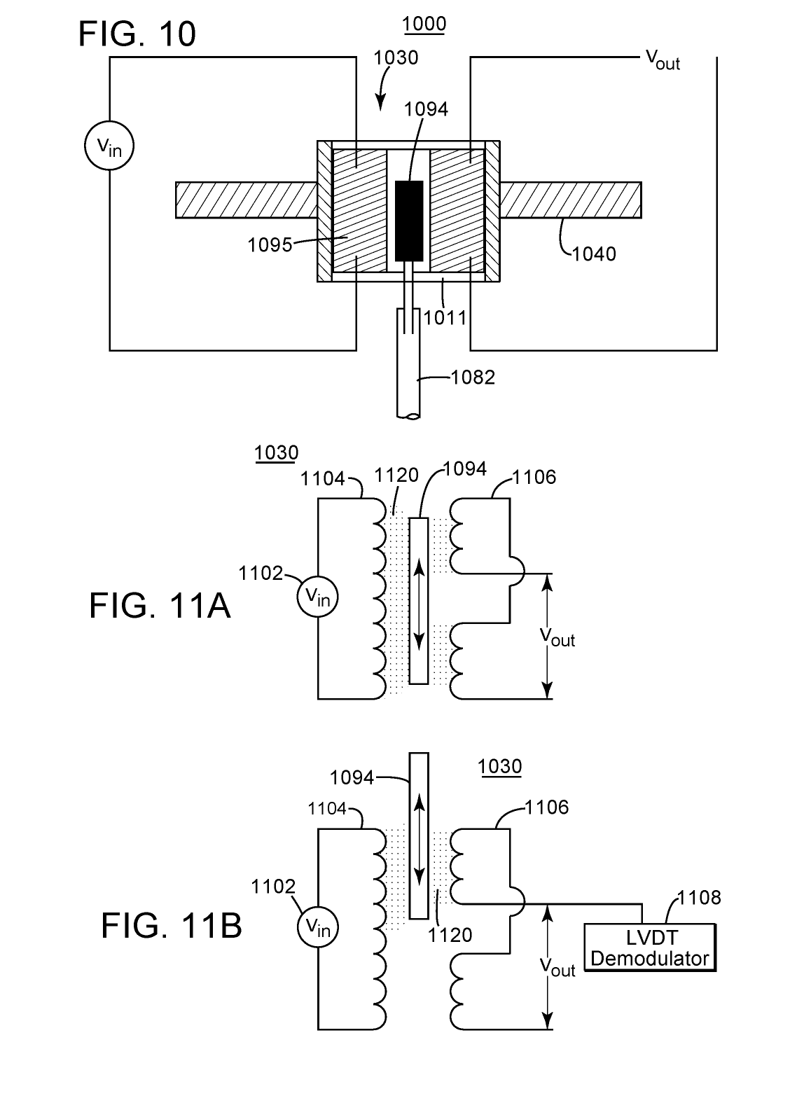

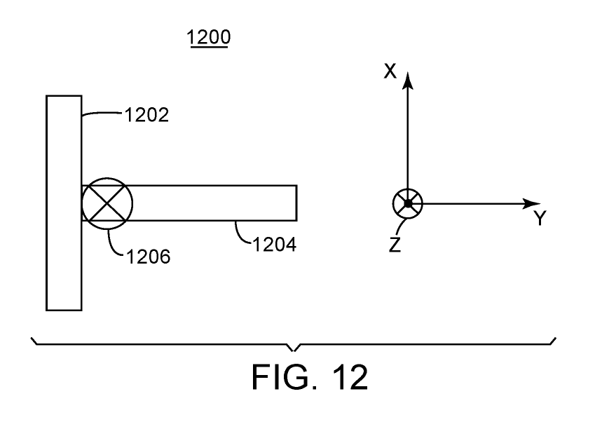

In still another embodiment, it is possible to measure the strain and not its derivative as now discussed with regard to FIG. 10. FIG. 10 shows a sensor device 1000 having a transducer assembly 1030 instead of magnetic assembly 330. The configuration of the sensor device is similar to that shown in FIG. 8. Rod 1082 is connected to a core 1094 of a Linear Variable Differential Transformer (LVDT) 1095. LVDT 1095 measure the strain in the ambient formation by measuring the change in distance between the center rod 1082 that is attached to a lower anchor plate (shown in FIG. 8) and an upper anchor plate 1040. In this case, an oscillator 1102 that generates an AC signal could be used to drive the primary LVDT winding 1104 as illustrated in FIGS. 11A-B. The secondary winding 1106 is comprised of two coils that are connected back to back, and they will have a net AC voltage Vout whose amplitude is directly proportional to core's 1094 position and whose polarity relative to the AC excitation signal will change depending upon whether the core is above or below the center/null position. FIG. 11A shows the LVDT core 1094 centered so that magnetic field 1120 generated by the primary winding 1104 is evenly coupled to both secondary windings 1106 to produce a net zero output. In FIG. 11B, the LVDT core 1094 is shown at the upper end of its travels so that the upper secondary coil of winding 1106 is well coupled to the magnetic field 1120 created by the primary winding 1104 while the lower secondary coil is not well coupled to create a net voltage output from the combined secondary windings. An LVDT demodulator 1108 could be used to convert the signal Vout to a seismic signal. Sensors capacitively coupled rather than inductively coupled can be configured to accomplish the same result.

Other options would include an optoelectric sensor that is sensitive to a change in distance or rate of change in distance between the center rod and the upper anchor. Instead of the optoelectric sensor, the sensor could be ultrasonic, an eddy current transducer, or a Hall effect type sensor (the hall effect sensor is used instead of a coil to detect the magnet's motion and/or position).

The above embodiments illustrated a single-component seismic sensor, i.e., a seismic sensor that measures a single time derivative of the strain of fill-in material in which the seismic sensor is placed. However, in one embodiment, as illustrated in FIG. 12, a multi-component seismic device 1200 could be constructed by arranging two or more single component sensors 1202, 1204 and 1206 along orthogonal axes X, Y and Z (axis Z is entering into the page in the figure). Components 1202 to 1206 may be any of the seismic sensors previously discussed. For example, the seismic device as shown in FIG. 3 is aligned with the Z axis, while another device is aligned with the X-axis and still another device is aligned with the Y-axis. While FIG. 12 shows each of the three single seismic sensors as having its own housing, it is possible that the three seismic sensors share a single housing. In another embodiment, the multi-component sensor could use a Galperin arrangement, i.e., an arrangement in which three orthogonal elements each make a 54 degree-35 minute angle with respect to the vertical axis.

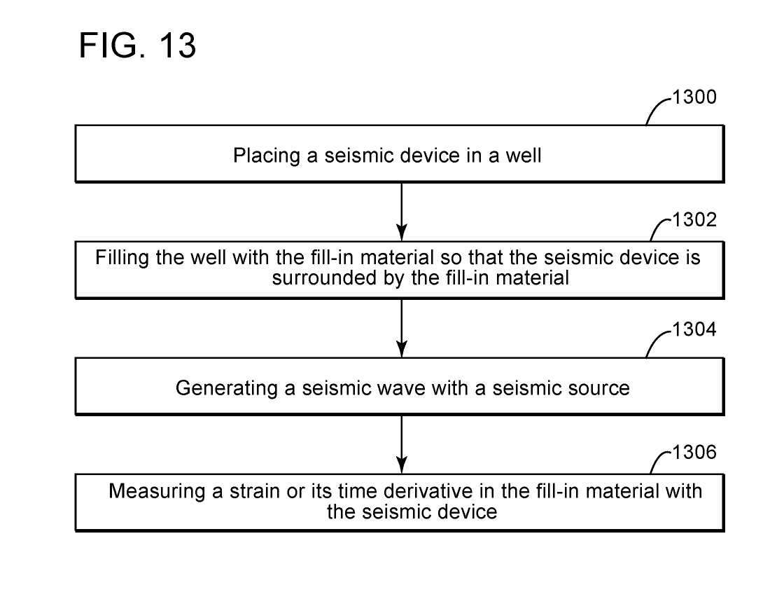

According to an embodiment illustrated in FIG. 13, there is a method for determining a time derivative of a strain in a fill-in material. The method includes a step 1300 of placing a seismic device in a borehole, a step 1302 of filling the well with the fill-in material so that the seismic device is surrounded by the fill-in material, a step 1304 of generating a seismic wave with a seismic source, and a step 1306 of measuring a strain or its time derivative in the fill-in material with the seismic device. The strain in the fill-in material is a result of the seismic wave passing through the fill-in material.

The disclosed embodiments provide a buried seismic sensor that is less sensitive to ground roll. It should be understood that this description is not intended to limit the embodiments. On the contrary, the embodiments are intended to cover alternatives, modifications, and equivalents, which are included in the spirit and scope of the embodiments as defined by the appended claims. Further, in the detailed description of the embodiments, numerous specific details are set forth to provide a comprehensive understanding of the claimed embodiments. However, one skilled in the art would understand that various embodiments may be practiced without such specific details. For example, the above described embodiments generally describe various types of seismic receivers which can be used for various seismic data acquisition applications. They can be used with any type of seismic source or application including, for example, fracture monitoring, passive seismic monitoring or other oil field activities. For these cases the seismic waves can be generated by any type of mechanism, e.g., natural events or man-made events, such as a drill bit, or fluid injection/fracking.

Although the features and elements of the embodiments are described in the embodiments in particular combinations, each feature or element can be used alone, without the other features and elements of the embodiments, or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

The above-described embodiments are intended to be illustrative in all respects, rather than restrictive, of the embodiments. Thus the embodiments are capable of many variations in detailed implementation that can be derived from the description contained herein by a person skilled in the art. No element, act, or instruction used in the description of the present application should be construed as critical or essential to the embodiments unless explicitly described as such. Also, as used herein, the article “a” is intended to include one or more items.

1. A seismic device for recording seismic waves, the device comprising:
a housing to be located in a fill-in material and/or a formation;
a first assembly located inside the housing; and
a first anchor attached to the first assembly and exiting through the housing to contact the fill-in material and/or the formation,
wherein the first assembly is configured to measure a quantity indicative of a strain experienced by the formation due to the seismic waves.

2. The seismic device of claim 1, wherein the quantity is the strain or a time derivative of the strain.

3. The seismic device of claim 1, further comprising:
a rigid member located inside the housing and attached to the first assembly; and
a second anchor attached to the rigid member and exiting through the housing to contact the fill-in material and/or the formation.

4. The seismic device of claim 3, wherein the first assembly comprises:
a magnet fixedly attached to an end of the rigid member; and
a coil located around the magnet and fixedly attached to the first anchor,
wherein the seismic waves determine a movement of the magnet and the rigid member relative to the coil.

5. The seismic device of claim 1, further comprising:
a second assembly located inside the housing; and
a second anchor attached to the second assembly and exiting through the housing to contact the fill-in material and/or the formation.

6. The seismic device of claim 5, wherein the first and second assemblies are magnetic assemblies located at opposite ends of the housing.

7. The seismic device of claim 5, wherein the first and second assemblies are located adjacent to each other, at a central position along a longitudinal axis of the housing.

8. The seismic device of claim 5, further comprising:
a rigid member located inside the housing, each end of the rigid member being attached to one of the first and second assemblies; and
a third anchor attached to the rigid member and exiting through the housing to contact the fill-in material and/or the formation.

9. The seismic device of claim 8, wherein
the first assembly comprises:
a first magnet fixedly attached to an end of the rigid member; and
a first coil located around the first magnet and fixedly attached to the first anchor; and
the second assembly comprises:
a second magnet fixedly attached to an end of the rigid member; and
a second coil located around the second magnet and fixedly attached to the second anchor.

10. The seismic device of claim 9, wherein the seismic waves determine a movement of the first magnet, the second magnet and the rigid member relative to the first and second coils, which induces a first voltage at the first magnetic assembly and a second voltage at the second magnetic assembly.

11. The seismic device of claim 10, wherein a difference between the first and second voltages is indicative of the time derivative of the strain of the formation.

12. The seismic device of claim 1, wherein the first assembly includes a piezoelectric material or a linear variable differential transformer.

13. A seismic device for recording seismic waves, the device comprising:
a housing to be embedded in a fill-in material and/or a formation;
a first magnetic assembly located inside the housing;
a second magnetic assembly located inside the housing; and
a rigid member located inside the housing and separating the first magnetic assembly from the second magnetic assembly,
wherein the first and second magnetic assemblies generate corresponding first and second voltages, a difference of which is indicative of a strain experienced by the formation due to the seismic waves.

14. The seismic device of claim 13, wherein
the first magnetic assembly comprises:
a first magnet fixedly attached to an end of the rigid member; and
a first coil located around the first magnet and fixedly attached to the first anchor;
the second magnetic assembly comprises:
a second magnet fixedly attached to an end of the rigid member; and
a second coil located around the second magnet and fixedly attached to the second anchor; and
a third anchor attached to the rigid member and exiting through the housing to contact the fill-in material and/or the formation.

15. The seismic device of claim 14, wherein the first, second and third anchors are embedded in cement.

16. The seismic device of claim 13, wherein the first and second magnetic assemblies are located at opposite ends of the housing.

17. The seismic device of claim 13, wherein the first and second magnetic assemblies are located adjacent to each other, at a central position along a longitudinal axis of the housing.

18. A method for determining a time derivative of a strain in a fill-in material and/or formation, the method comprising:
placing a seismic device in a well;
filling the well with the fill-in material so that the seismic device is surrounded by the fill-in material;
generating a seismic wave with a seismic source; and
measuring a quantity indicative of a strain in the fill-in material and/or the formation with the seismic device, wherein the strain in the fill-in material and/or the formation is a result of the seismic wave passing through the fill-in material and/or the formation.

19. The method of claim 18, wherein the seismic device includes first and second magnetic assemblies,
the first magnetic assembly comprises:
a first magnet fixedly attached to an end of the rigid member; and
a first coil located around the first magnet and fixedly attached to the first anchor;
the second magnetic assembly comprises:
a second magnet fixedly attached to an end of the rigid member; and
a second coil located around the second magnet and fixedly attached to the second anchor; and
a third anchor attached to the rigid member and exiting through the housing to contact the fill-in material and/or the formation.

20. The method of claim 18, wherein the fill-in material is cement.
